(19) United States
(12) Patent Application Publication
(10) Pub. No.: US 2005/0167895 A1
(43) Pub. Date: Aug. 4, 2005

(54) Method of producing a ceramic component

(75) Inventors: Anne-laure Penard, Limoges (FR); Fabrice Rossignol, Limoges (FR); Thierry Chartier, Limoges (FR); Cecile Pagnoux, Limoges (FR); Matthew Murphy, Limerick (IE); Christophe Cueille, Herouville Saint Clair (FR); Gerard Insley, Limerick (IE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Howmedica Osteonics Corp., Mahwah, NJ (US)

(21) Appl. No.: 10/979,505

(22) Filed: Nov. 2, 2004

(30) Foreign Application Priority Data
Nov. 10, 2003 (GB) 0326183.1

(51) Int. Cl. C04B 35/00

(52) U.S. Cl. 264/621; 264/667

(57) ABSTRACT

A method of producing a ceramic component includes dispersing an alpha-alumina nanopowder whose diameter is above 100 nm in water, using 2-phosphonobutane-1,2,4-tricarboxylic acid (PBTC) or 4,5-Dihydroxy-m-benzenedisulfonic Acid, Disodium Salt (Tiron™) as dispersant. The pH is shifted towards the isoelectric point (IEP) by adding a mixture of acetic anhydride and ethylene glycol or polyethylene glycol, drying in a controlled atmosphere (humidity, temperature) and post compacting using cold isostatic pressing and sintering the three-dimensional structure thus formed.

### BACKGROUND OF THE INVENTION

This invention relates to a method of producing a ceramic component using a direct coagulation casting process.

Direct coagulation casting (DDC) comprises coagulating a concentrated dispersed suspension into a solid state to get cohesive green parts exhibiting a low shrinkage during their dying. The liquid to solid transformation occurs during the consolidation and is controlled by the electrostatic forces that act on the particles. Repulsive forces, created during the dispersion stage, are progressively and uniformly annealed by attractive forces resulting from the modification of the chemistry near the surface of powders. One approach of DDC, initially proposed by Gauckler, (L. J. Gauckler, T. Graule, F. Baader, Ceramic Forming Using Enzyme Catalysed Reactions, Materials Chemistry and Physics, 61, 78-102 (1999) Gauckler's initial Patent on DCC: U.S. Pat. No. 5,948,335, Sep. 7, 1999, “Method for the forming of ceramic green parts” and B. Balzer, M. K. M. Hruschka, L. J. Gauckler, Coagulations kinetics and mechanical behaviour of wet alumina bodies produced via DDC, Journal of Colloid and Interface Science. 216, 379-386 (1999).) and later developed by SPCTS, (R. Laucournet, C. Pagnoux, T. Chartier and J. F. Baumard, Coagulation method of aqueous concentrated alumina suspensions by thermal decomposition of hydroxyaluminium diacetate, Journal of the American Ceramic Society, 83 [11], 2661-2667 (2000).), consists in destabilizing a highly concentrated suspension once this suspension has been casted into a non-porous mould, totally hermetic, in setting in motion a time-delayed chemical reaction. The coagulation may be catalysed by the temperature.

According to the DVLO theory, the stability of a dispersed suspension depends on two main factors which are the pH and ionic strength. In the DDC process, (A. Dakskobler, T. Kosmac, Weakly Flocculated Aqueous Suspensions Prepared By The Addition Of Mg(II) ion, Journal of the American Ceramic Society, 83 [3], 666-668 (2000); A. Dakskobler, T. Kosmac, Destabilization Of An Alkaline Aqueous Suspension By The Addition Of Magnesium Acetate, Colloids and Surfaces: A Physiochemical And Engineering Aspects. 195, 197-203 (2001); J. Davies, J. G. P. Binner, Coagulation Of Electrosterically Dispersed Concentrated Alumina Suspensions For Paste Production, Journal of the European Ceramic Society. 20, 1555-1567 (2000); J. Davies, J. P. G. Binner, Plastic Forming Of Alumina From Coagulated Suspensions, Journal of the European Ceramic Society. 20, 1569-1577 (2000); and G. V. Francks, N. V. Velamakanni, F. F. Lange, Vibraforming And In Situ Flocculation Of Consolidated Coagulated Alumina Slurries, Journal of the American Ceramic Society. 78 [5], 1324-1328 (1995). A coagulant agent is added after the dispersion stage. This agent includes a chemical reaction, and the products of this reaction allow to increase the ionic strength and/or to shift the pH towards the isoelectric point (IEP), which, at the end, leads to the destabilization of the suspension. After consolidation, the shaped body is dried under controlled atmosphere (temperature as well as humidity) and then sintered.

### SUMMARY OF THE INVENTION

One aspect of the present invention is intended to provide a method of direction coagulation casting to produce ceramic components which are particularly, although not essentially, for the biomedical industry. These and other aspects of the present invention are provided by a method of producing a ceramic component comprising disbursing an alpha-alumina nanopowder whose diameter is above 100 nm in water, using 2-phosphonobutane-1,2,4-tricarboxylic acid (PBTC) or 4,5-Dihydroxy-m-benzenedisulfonic Acid, Disodium Salt (Tiron™) as dispersant, shifting the pH towards the isoelectric point by adding a mixture of acetic anhydride and ethylene glycol, or polyethylene glycol. The mixture is then dried in a controlled and post compacted using cold isostatic pressing and sintering the three-dimensional structure thus formed. Preferably, the nanopowder is an oxide powder with a metal cation able to exhibit a strong absorption of PBTC molecules. The PBTC is mixed with water after the powder is added. The powder may be added in several stages with an ultrasonic treatment between each stage and a binder is added after dispersion. A d-aeration stage under vacuum is carried out to remove air bubbles after the ultrasound treatment. A thermal stabilization stage may be applied to obtain a desired dispersion temperature.

The acetic anhydride acts as a coagulant agent and is mixed with a co-solvent to increase the miscibility of the acetic anhydride and water and to slow down the hydrolysis kinetics of the acetic anhydride. The coagulant and its co-solvent should be added to the suspension while mixing in a way to avoid the creation of air bubbles. Once the coagulant is mixed into the suspension and before coagulation, the suspension is cast in a non-porous mold in which coagulation occurs. The coagulated body is then dried, taken out of the mold and then compacted by cold isostatic pressing and finally sintered.

### BRIEF DESCRIPTION OF THE DRAWINGS

The present invention will be better understood on reading the following detailed description of non-limiting embodiments thereof, and on examining the accompanying drawings, in which:

FIG. 1 is a flow chart of the process of the present invention.

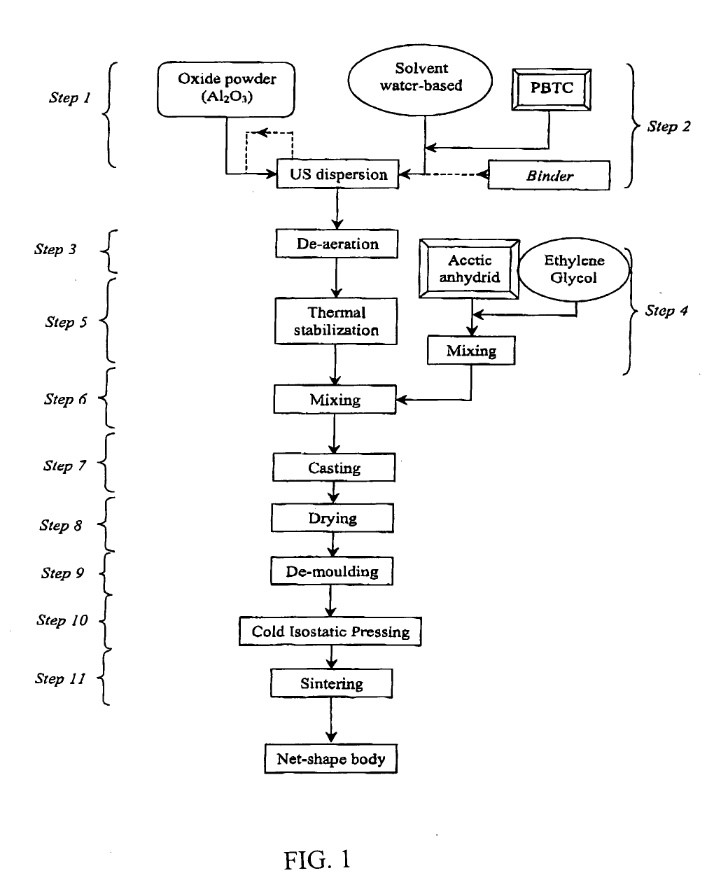

### DETAILED DESCRIPTION

According to the present invention a method of producing a ceramic component includes dispersing an alpha-alumina nanopowder whose diameter is above 100 nm in water, using 2-phosphonobutane-1,2,4-tricarboxylic acid (PBTC) or 4,5-Dihydroxy-m-benzenedisulfonic Acid, Disodium Salt (Tiron™) as dispersant, shifting the pH towards the isoelectric point (IEP) by adding a mixture of acetic anhydride and ethylene glycol, or polyethylene glycol, drying in a controlled atmosphere (humidity, temperature) and post compacting using cold isostatic pressing and sintering the three-dimensional structure thus formed.

The alpha-alumina particle diameter can be between 100 nm and 5 μm.

By using PBTC as an electrostatic dispersant for alumina nanopowders the repulsive negative charges at the alumina surface are the result of the ionized carboxylic and phosphonate groups of the grafted PBTC molecules. The time-delayed coagulation is achieved by shifting the pH towards the IEP when adding the acetic anhydride that transforms into acetic acid at the contact with water. The acetic anhydride is introduced with ethylene glycol and co-solvent to increase its miscibility in water and thus get an homogeneous coagulation, ethylene glycol also generates a lubricant effect which is beneficial to the cold isostatic pressing.

The nanopowder is preferably an oxide powder with a metal cation, able to exhibit a strong absorption of the PBTC molecules (e.g. alumina nanopowders). The solvent can be water base, for example demineralised, high purity and/or sterile water.

The elaboration of the concentrated suspension (i.e. solid loading over 55 vol. %) is achieved by first dissolving the PBTC (i.e. about 1 ppm of PBTC mol per m² of oxide powder surface) into the solvent and after the powder is added. It is possible to add the powder in several stages, with an ultrasonic (US) treatment between each additional stage.

In order to achieve dispersion, a deagglomeration and/or milling treatments (for example, ball milling, attrition milling) are used and it is also possible to add a binder after dispersion. A de-aeration stage under vacuum (<50 mbar) is carried out to remove air bubbles that exist in the suspension after US treatments.

A thermal stabilization of the well-dispersed suspension at a temperature around 5° C. is then carried out to delay the coagulation when adding the coagulant, thus providing time for casting.

Acetic anhydride is used as the coagulant agent. Since it is every sensitive to water, it has to be mixed with a co-solvent that helps to increase the miscibility of acetic anhydride in water and slow down the hydrolysis kinetics of acetic anhydride.

The temperature has to be set to a desired one for the same reason as set forth in the thermal stabilization stage.

The blend of coagulant and its co-solvent is added to the suspension while mixing. This mixing should be adapted to avoid the creation of air bubbles, for example, it can be ensured mechanically by a rotating blade whose design depends on the viscosity of the suspension. It is also very important to reach a homogeneous distribution of the coagulant within the entire volume of the suspension to further obtain a uniform coagulation.

Preferably casting takes place once the coagulation is mixed to the suspension and before coagulation, the suspension being cast in a non-porous mold in which coagulation occurs.

Once the body is coagulated, it is necessary to dry and de-mold it. It is preferable to first start dying the body in the mold in order to strengthen it and then to de-mold it after. If the drying is done in the mold, the mold can be designed to prevent any stresses or cracks. If de-molding is done first, the coagulated body has to be strengthened to avoid any deformations.

Once again, the drying has to be carried out under controlled atmospheres (temperature and humidity) to avoid cracking of the body.

The dried compacts are further post-compacted by cold isostatic pressing at a pressure of 2,000 bars.

Tiron (4,5-Dihydroxy-m-benzenedisulfonic Acid, Disodium Salt) can be used in place of PBTC to achieve similar results.

The final sintering stage will give the final properties to the body. The sintering process can be as simple as natural sintering.

The invention can be carried out in various ways but one method of producing a ceramic component as set forth will now be described by way of example and with reference to the accompanying drawing which is a flow diagram of the process.

The alpha-alumina nanopowder used exhibits a surface area of 7 m²/g and a theoretical density of 3.98 g.cm⁻³, and a particle diameter range from 100 nm to 5 μm.

The first step comprises preparing a concentrated suspension, for example 100 ml of suspension with a solid loading of 58 vol. %. Such a solid loading is practically the maximum which can be used with the alumina powder whose characteristics are described here above (over 58 vol. %, the viscosity would be too high to get a good de-aeration of concentrated suspension). The weight of the alumina powder necessary to be added is then equal to 230.84 g, which also corresponds to a surface of 1615.9 m². The optimum quantity of dispersant (i.e. the one conducting to the minimum viscosity) has been determined to be equivalent to 10⁻⁶ mol of 2-phosphonobutane-1,2,4-tricarboxylic acid (PBTC) per square meter of alumina powder surface. Actually, PBTC is introduced as a tetra-sodium salt (PBTC-Na₄) whose molar mass is equal to 358 g. A quantity of 0.578 g of PBTC-NA₄ is then dissolved in 42 ml of demineralized water prior to the addition of the alumina powder.

58 vol. % of solid is a very high solid loading. It is then necessary to add the powder in two stages. 40 vol. % are initially added and the second step described here below is applied. The remaining 18 vol. % of alumina powder is then introduced and again the second step is applied.

The second step comprises using an ultrasonic treatment for the deagglomeration of the alumina powder. The ultrasonic energy has to be high enough (700 Watts) to break strong agglomerates. To prevent from the heating of the suspension upon the energy brought by the ultrasounds, 1 second pulses are applied every three seconds over a duration of 2 minutes. A cooling system may also contribute to reduce the heating.

The third step comprises the de-aeration of the concentrated suspension which can be done in a chamber under a vacuum below 50 mbars.

The fourth step comprises preparing a mixture of acetic anhydride (coagulant) and ethylene glycol (co-solvent), or alternatively, polyethylene glycol can be used in the following proportions in volume: 1/8 of acetic anhydride and 7/8 of ethylene glycol or polyethylene glycol.

The fifth step consists cooling down to 5° C. the temperature of the concentrated suspension and the mixture of coagulant and co-solvent.

The sixth step comprises mixing the 100 ml of concentrated suspension with 8 ml of the mixture of coagulant and co-solvent under mechanical agitation with a blade rotating at few rpm to prevent cavitation (creation of air bubbles).

The seventh step comprises casting into a non-porous mold based, for instance, on silicon, latex, or Teflon. Once cast the coagulation proceeds at room temperature in less then five minutes. Non-porous rigid and/or flexible molds are used (lubricants such as Vaseline, Teflon or high purity olive oil can be used to aid removal of the part from the mold).

The eighth step comprises drying the three dimensional wet body directly inside the mold. The drying temperature and the humidity are adjusted depending on the shape and size of the part. Typically, an increase of the temperature and hygrometry inhibits the creation of cracks, but both have to be adapted depending on the size and shape of the part of to be dried.

The ninth step comprises de-molding the dried green part.

The tenth step comprises of cold isostatic pressing (CIP) the dried green part at 2,000 bars pressure using, for instance, latex or silicone-based resins as the surrounding capsule.

Green densities obtained are above 60% of theoretical density. A cold isostatic pressing (CIP) stage can be used thanks to the mobility of the grains because of the specific system used, for example good flow of grains enable formation of a more dense compact.

A bottom-up approach is used with pure alpha-alumina to control the type and content of further added additives, such as magnesium oxide, gamma-alumina, silicon, zirconia, etc.

The eleventh step comprises sintering the part to a density close to the theoretical one by applying a natural sintering at 1600° C. for two hours.

The main benefits of this process are the ability to produce ceramic components requiring minimal machining once sintered as well as the production of ceramic shapes previously unobtainable with current manufacturing processes. Compared to a classical DCC process using enzymes (Gauckler), it is very fast since a homogeneously coagulated body can be obtained within 5 minutes.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of producing a ceramic component comprising dispersing an alpha-alumina nanopowder whose diameter is above 100 nm in water, using 2-phosphonobutane-1,2,4-tricarboxylic acid (PBTC) or 4,5-Dihydroxy-m-benzenedisulfonic Acid, Disodium Salt (Tiron™) as dispersant, shifting the pH towards the isoelectric point (IEP) by adding a mixture of acetic anhydride and ethylene glycol, or polyethylene glycol, drying in a controlled atmosphere (humidity, temperature) and post compacting using cold isostatic pressing and sintering the three-dimensional structure thus formed.

2. The method as claimed in claim 1 in which the nanopowder is an oxide powder with a metal cation, able to exhibit a strong absorption of PBTC molecules, for example Demineralized, high purity and/or sterile water.

3. The method as claimed in claim 1 in which the PBTC is first mixed to water and after the powder is added.

4. The method as claimed in claim 1 in which the powder is added in several stages with an ultrasonic (US) treatment between each addition stage.

5. The method as claimed in claim 4 in which a binder is added after dispersion.

6. The method as claimed in claim 4 in which a de-aeration stage under vacuum is carried out to remove air bubbles after US treatments.

7. The method as claimed in claim 1 in which a thermal stabilization stage is applied to obtain a desired dispersion temperature.

8. The method as claimed in claim 1 in which the acetic anhydride acts as a coagulant agent and is mixed with co-solvent to increase the miscibility of the acetic anhydride in water, and to slow down the hydrolysis kinetics of acetic anhydride.

9. The method as claimed in claim 7 in which the blend of the coagulant with its co-solvent is added to the suspension while mixing and avoiding the creation of air bubbles.

10. The method as claimed in claim 8 in which the blend of the coagulant with its co-solvent is added to the suspension while mixing and avoiding the creation of air bubbles.

11. The method as claimed in claim 9 which includes mixing mechanically by a rotating blade.

12. The method as claimed in claim 9 in which, once the coagulant is mixed to the suspension and before coagulation, the suspension is cast in a non-porous mould in which coagulation occurs.

13. The method as claimed in claim 12 in which the body is coagulated and is dried and de-molded before sintering.

14. The method as claimed in claim 12 in which the dried compacts are further post-compacted by cold isostatic pressing.

15. The method as claimed in claim 10 which includes mixing mechanically by a rotating blade.

16. The method as claimed in claim 10 in which, once the coagulant is mixed to the suspension and before coagulation, the suspension is cast in a non-porous mould in which coagulation occurs.

17. A method of producing a ceramic component comprising preparing a suspension of alumina powder in water wherein the alumina powder is less than 58% by volume;
ultrasonically treating the suspension;
de-aerating the suspension;
mixing the alumina suspension with a coagulant and a co-solvent;
forming the mixture into a three dimensional wet body and thereafter drying the body; and
pressing the dried body and thereafter sintering the body to form the ceramic component.

18. The method as set forth in claim 17 wherein the alumina powder suspension is less than 58% by volume alumina powder.

19. The method as set forth in claim 18 wherein the alumina powder is mixed in the suspension in two stages.

20. The method as set forth in claim 19 wherein the two stages are a first stage of 40% alumina powder or less by volume and the second stage is 18% or less by volume.

21. The method as set forth in claim 17 wherein the deaeration of the suspension is done in a chamber under a vacuum.

22. The method as set forth in claim 17 wherein the coagulant is acetic anhydride and the co-solvent is ethylene glycol.

23. The method as set forth in claim 22 wherein a mixture is prepared 1/8 by volume of acetic anhydride and 7/8 by volume of ethylene glycol.

24. The method as set forth in claim 17 wherein the temperature of the alumina powder suspension and the mixture of coagulant and co-solvent is cooled to 5° C. prior to mixing.

25. The method as set forth in claim 17 wherein the ratio of alumina powder suspension to the mixture of coagulant and co-solvent is 100 ml of suspension to 8 ml of coagulant and co-solvent.

26. The method as set forth in claim 17 wherein the wet body is dried at a predetermined temperature and humidity.

27. The method as set forth in claim 17 wherein the pressing of the dried body is by cold isostatic pressing at a pressure of 2,000 bars.

28. The method as set forth in claim 17 wherein the sintering takes place at 1600° C. for 2 hours.
